(19) United States
(12) Patent Application Publication
(10) Pub. No.: US 2026/0091530 A1
(43) Pub. Date: Apr. 2, 2026

(54) CUTTING DEVICE OF EDGE BANDING MACHINE

(71) Applicant: OAV EQUIPMENT AND TOOLS, INC., Taichung City (TW)

(72) Inventor: YEN-TSUNG CHANG, Taichung City (TW)

(21) Appl. No.: 18/901,291

(22) Filed: Sep. 30, 2024

(51) Int. Cl. B27B 31/00

(52) U.S. Cl. CPC B27B 31/003

(57) ABSTRACT

A cutting device of an edge banding machine is provided, and the edge banding machine includes a conveying mechanism configured to convey a board along a first direction. The cutting device includes a base, a cutting assembly, at least one abutting assembly and a first moving mechanism. The cutting assembly includes a seat, at least one blade and a driving motor. The at least one blade is disposed on the seat and includes a plurality of cutting teeth, and each of the plurality of cutting teeth includes a first edge portion and a second edge portion, and each said second edge portion is disposed on a side of one said first edge portion and has an arcuate surface. The at least one blade is drivable to move in a second direction lateral to the first direction by the first moving mechanism.

### BACKGROUND OF THE INVENTION

### Field of the Invention

The present invention relates to a cutting device of an edge banding machine.

### Description of the Prior Art

An edge banding machine is used to adhere an edge band to a surface of a board so that a cut edge of the board is covered by the edge band so as to have good appearance and be smooth and not thorny. Generally, the edge banding machine includes a conveyor, a pressing wheel set disposed above the conveyor and an edge band conveying mechanism. The board is clamped and moved between the conveyor and the pressing wheel set, and the edge band conveying mechanism is adapted to convey the edge band to a side of the board so as to achieve automatic edge-banding effect. The edge banding machine further includes a cutting mechanism which is configured to cut off excess portions of the edge band after being adhered to the board.

The edge band has sharp edges after being cut, which requires additional trimming process to make the sharp edges smooth and have preferable appearance. However, the conventional cutting mechanism can only be used to cut the edge band. A trimming mechanism has to be arranged in the edge banding machine, or a trimming process should be performed after edge banding, which results in a bulky device, low production efficiency and other problems. In addition, the trimming mechanism has to change a position of its cutter to adjust a cutting depth, which is inconvenient to operate, and the positioning of the cutter is inaccurate and unreliable.

The present invention is, therefore, arisen to obviate or at least mitigate the above-mentioned disadvantages.

### SUMMARY OF THE INVENTION

The main object of the present invention is to provide a cutting device of an edge banding machine, which is easy to adjust a cutting depth and can efficiently cut and trim an edge band.

To achieve the above and other objects, the present invention provides a cutting device of an edge banding machine, and the edge banding machine includes a conveying mechanism configured to convey a board along a first direction. The cutting device of the edge banding machine includes a base, a cutting assembly, at least one abutting assembly and a first moving mechanism. The base is configured to be disposed on a side of the conveying mechanism. The cutting assembly includes a seat, at least one blade and a driving motor, and the at least one blade is disposed on the seat and includes a plurality of cutting teeth. Each of the plurality of cutting teeth includes a first edge portion and a second edge portion, and each said second edge portion is disposed on a side of one said first edge portion in the first direction and has an arcuate surface. The at least one blade is drivable to rotate about a rotation axis parallel to the first direction by the driving motor. The at least one abutting assembly is disposed on a side of the seat facing toward the conveying mechanism. The first moving mechanism is disposed between the base and the cutting assembly, and the at least one blade is drivable to move back and forth in a second direction lateral to the first direction by the first moving mechanism. Each of the at least one abutting assembly includes an abutting surface configured to be abutted against the board, the at least one blade partially protrudes beyond the abutting surface, and a position of the abutting surface relative to the seat is adjustable in the second direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a partial enlargement of a preferable embodiment of the present invention in use;

FIG. 3 is a partial cross-sectional view of a preferable embodiment of the present invention;

FIG. 4 is a top view of a preferable embodiment of the present invention when a blade is in a first cutting position;

FIG. 5 is a top view of a preferable embodiment of the present invention when the blade is in a second cutting position;

FIG. 6 is a side view of FIG. 5;

FIG. 7 is a top view of a preferable embodiment of the present invention when the blade is in an original position;

FIG. 8 is a side view of FIG. 7; and

FIG. 9 is a drawing showing operation of another blade according to a preferable embodiment of the present invention.

### DETAILED DESCRIPTION OF THE PREFERRED EMBODIMENTS

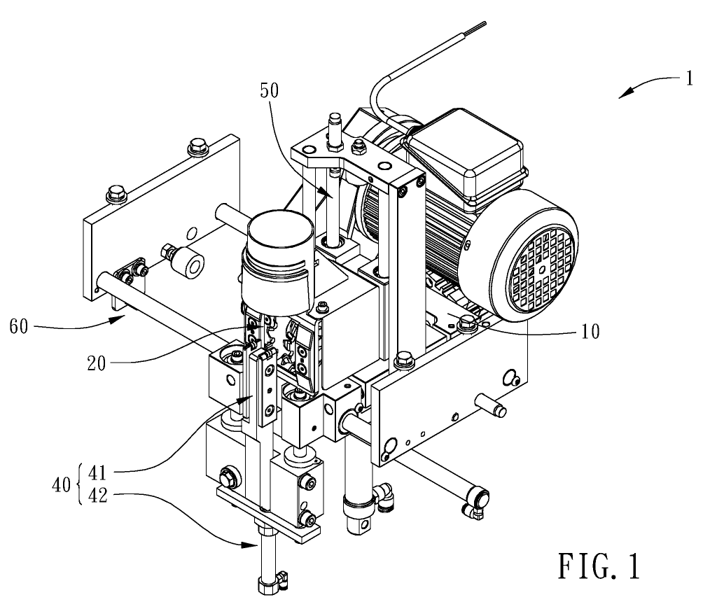

Please refer to FIGS. 1 to 9 for a preferable embodiment of the present invention. A cutting device of an edge banding machine 1 of the present invention includes a base 10, a cutting assembly 20, at least one abutting assembly 70 and a first moving mechanism 30. The edge banding machine includes a conveying mechanism 3 configured to convey a board 2 in a first direction D1.

The base 10 is configured to be disposed on a side of the conveying mechanism 3. The cutting assembly 20 includes a seat 21, at least one blade 22 and a driving motor 23, and the at least one blade 22 is disposed on the seat 21 and includes a plurality of cutting teeth 221. Each of the plurality of cutting teeth 221 includes a first edge portion 222 and a second edge portion 223, and each said second edge portion 223 is disposed on a side of one said first edge portion 222 in the first direction D1 and has an arcuate surface 223a. The at least one blade 22 is drivable to rotate about a rotation axis R parallel to the first direction D1 by the driving motor 23. The at least one abutting assembly 70 is disposed on a side of the seat 21 facing toward the conveying mechanism 3. The first moving mechanism 30 is disposed between the base 10 and the cutting assembly 20, and the at least one blade 22 is drivable to move back and forth in a second direction D2 lateral to the first direction D1 by the first moving mechanism 30 so that the arcuate surface 223a can contact and trim an edge of an edge band 2a of the board 2 into a rounded corner. Each of the at least one abutting assembly 70 includes an abutting surface 711 configured to be abutted against the board 2, the at least one blade 22 partially protrudes beyond the abutting surface 711, and a position of the abutting surface 711 relative to the seat 21 is adjustable in the second direction D2. Therefore, a position of the at least one blade 22 relative to the board 2 is adjustable to change a cutting depth.

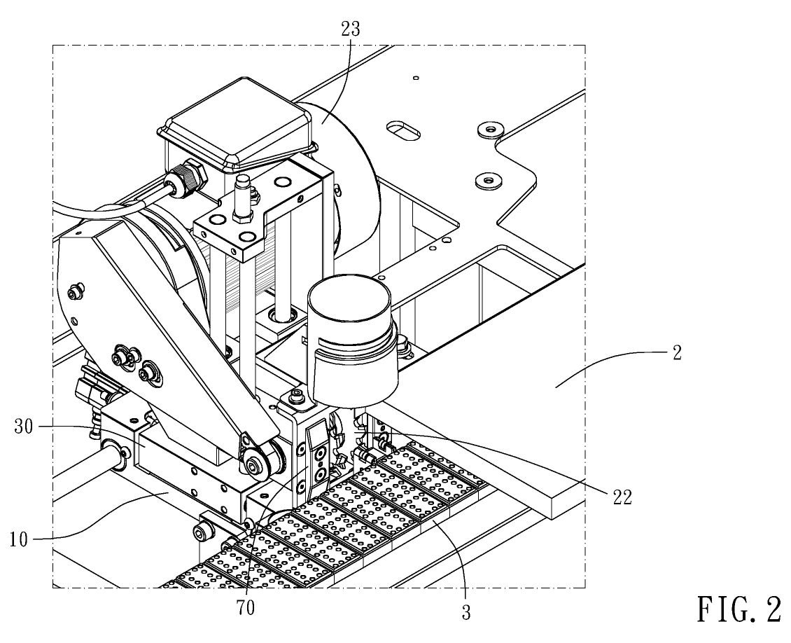

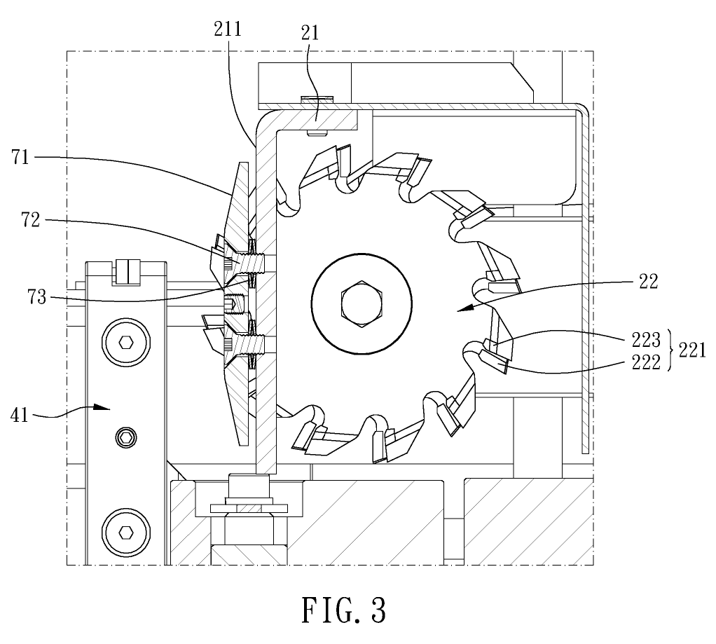

Please refer to FIGS. 2 and 3, the seat 21 includes a mounting surface 211 and an opening 212 disposed through the mounting surface 211. The at least one abutting assembly 70 is disposed on the mounting surface 211, and the at least one blade 22 protrudes beyond the mounting surface 211 from the opening 212. Specifically, each of the at least one abutting assembly 70 includes a supporting plate 71 and at least one adjustment member 72 connected between the supporting plate 71 and the seat 21. Each said supporting plate 71 has one said abutting surface 711 disposed thereon, and the at least one adjustment member 72 is rotatable to drive the said abutting surface 711 to move in the second direction D2, which is easy to operate and provides good accuracy. Preferably, each of the at least one abutting assembly 70 further includes at least one elastic member 73 disposed between one said supporting plate 71 and the seat 21, and the at least one elastic member 73 is elastically urged the said supporting plate 71 to move in a direction remote from the seat 21 so as to prevent the said supporting plate 71 from shaking for good stability. In this embodiment, each said supporting plate 71 is made of a metallic material, which is not easy to deform, facilitates accurate positioning and has good durability. Each said supporting plate 71 further has two inclined surfaces 712 connected with two opposite sides of one said abutting surface 711, and each said abutting surface 711 extends in a direction parallel to the first direction D1. Each said abutting surface 711 is configured to be stably abutted against the board 2 to achieve positioning of the board 2 relative to the at least one blade 22. Preferably, each of the at least one abutting assembly 70 includes two said adjustment members 72 spacedly disposed through one said supporting plate 71 and a plurality of said elastic members 733. Each of the two said adjustment members 72 is a screwing member screwed to the seat 21, and each of the plurality of said elastic members 73 is a spring washer sleeved to one of the two said adjustment members 72, which has a simple structure, is easy to be assembled and adjusted, and prevents the said supporting plate 71 from rotation.

To adjust the cutting depth to the edge band 2a, said adjustment members 72 are loosen or tightened to drive the abutting surface 711 to move in the second direction D2, and a contact surface of said second edge portions 223 and the edge band 2a are changed to generate different trimming effect. For example, when a distance between each said abutting surface 711 and the mounting surface 211 is larger, a cut surface of the edge band 2a and the said second edge portions 223 have smaller contact areas therebetween, and the cutting depth is shallow. When the distance between each said abutting surface 711 and the mounting surface 211 is smaller, the cut surface of the edge band 2a and the said second edge portions 223 have larger contact areas therebetween, and the cutting depth is deep.

In this embodiment, each of the at least one blade 22 is a circular saw blade, and each said second edge portion 223 is located radially inward of the circular saw blade relative to each said first edge portion 222, as shown in FIG. 3. The cutting assembly 20 further includes a transmission shaft 24 disposed on the seat 21, and the driving motor 23 drives the transmission shaft 24 to rotate so that the circular saw blade is rotated to cut and trim the edge band 2a. In other embodiments, each said second edge portion may have an inclined surface so that an edge of the edge band can be trimmed into a chamfer.

Specifically, the at least one blade 22 is drivable to move in the second direction D2 between an original position, a first cutting position and a second cutting position by the first moving mechanism 30. When the at least one blade 22 is in the original position, the at least one blade 22 is free of interference with the board 2, and the board 2 can be passed therethrough. When the at least one blade 22 is in the first cutting position, at least one of the said first edge portions 222 is configured to be interfered with the edge band 2a, and the said first edge portions 222 cut off an excess portion of a front end of the edge band 2a. When the at least one blade 22 is in the second cutting position, at least one of the said second edge portions 223 is configured to be interfered with the edge band 2a, and the said second edge portions 223 trim an edge of the cut surface of the edge band 2a into the arcuate surface.

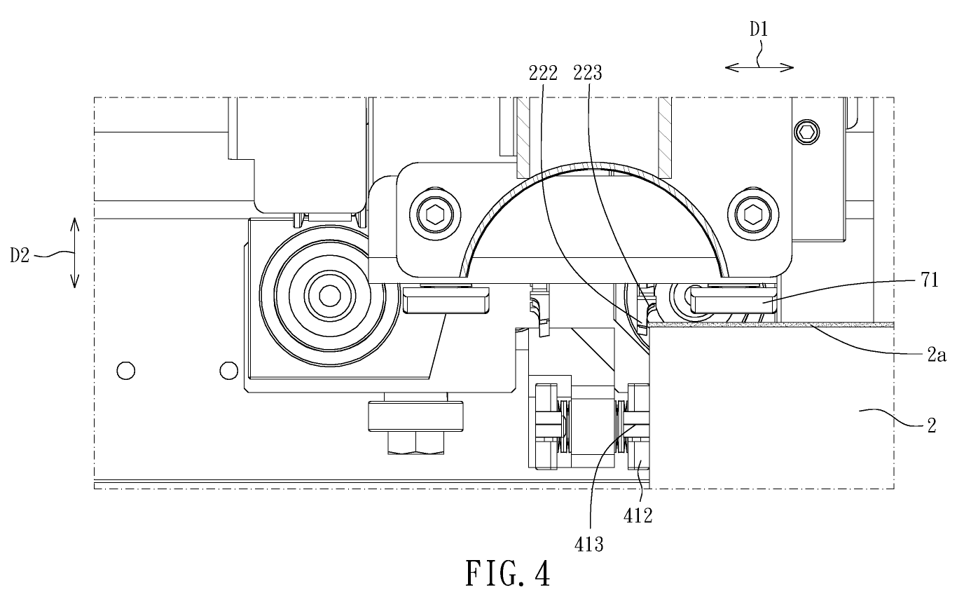

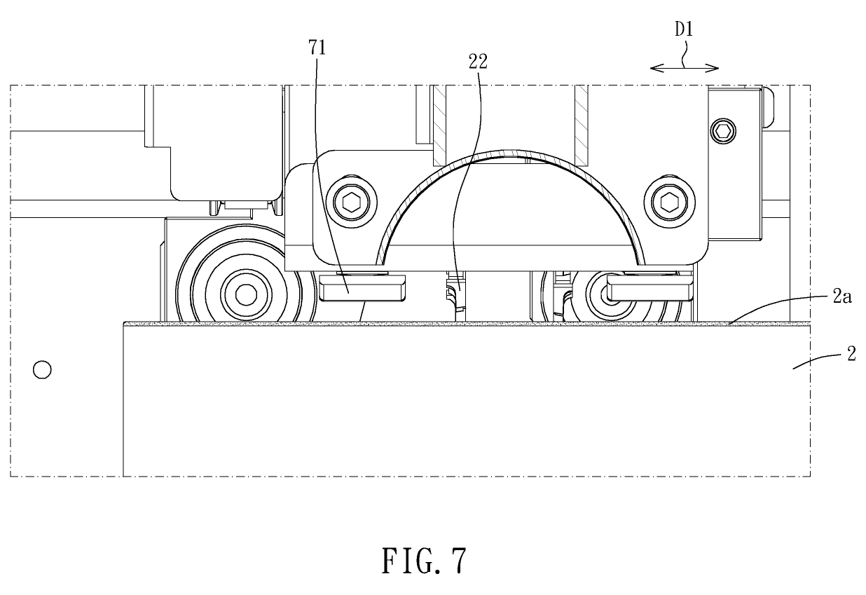

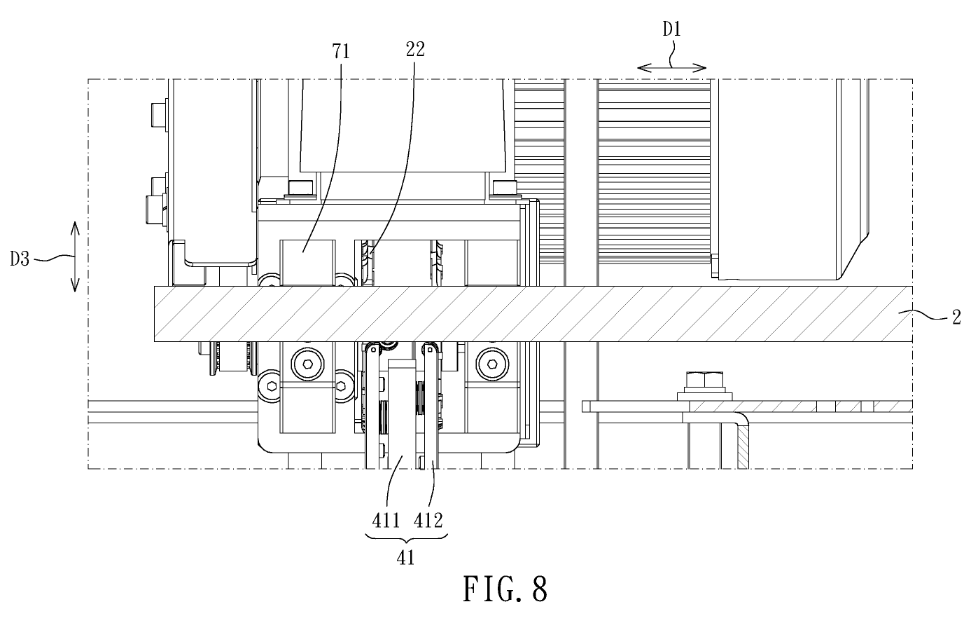

The cutting device of the edge banding machine 1 further includes a pushing assembly 40 disposed on the base 10, and the pushing assembly 40 includes a push rod 41 and a second moving mechanism 42. The push rod 41 is configured to be arranged between the at least one blade 22 and the conveying mechanism 3 and abuttable against the board 2 in the first direction D1, and the push rod 41 is drivable to move in a third direction D3 vertical to the first direction D1 between a first position and a second position by the second moving mechanism 42. When the push rod 41 is in the first position, the board 2 is abuttable against the push rod 41 in the first direction D1, as shown in FIGS. 4 to 6 and FIG. 9, and a position of the board 2 relative to the at least one blade 22 is restricted, which prevents the board 2 from being moved during cutting. When the push rod 41 is in the second position, the push rod 41 is free of interference with the board 2 in the first direction D1, as shown in FIGS. 7 and 8, and the board 2 can be moved in the first direction D1.

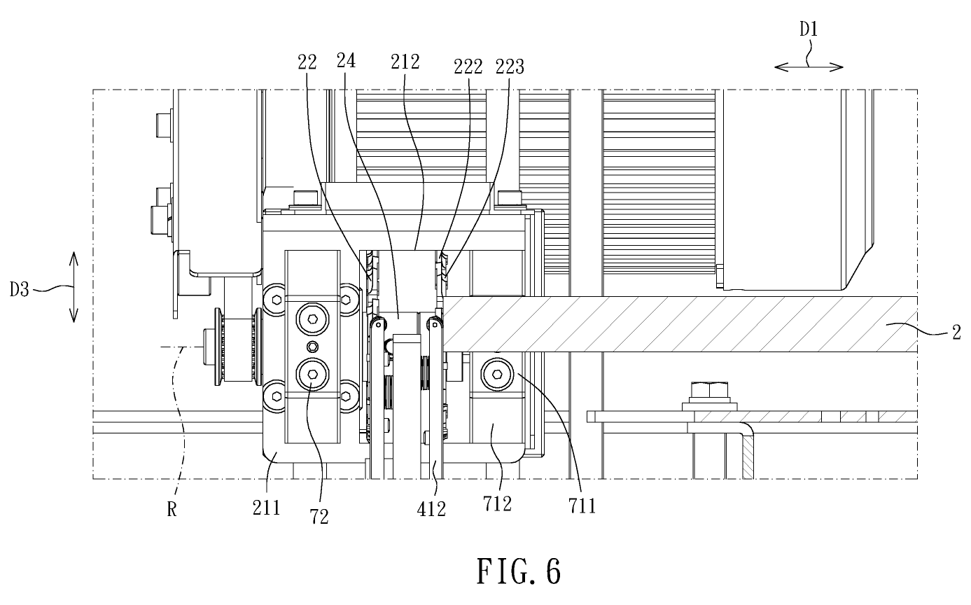

Moreover, the push rod 41 includes a rod member 411 and two side plates 412 disposed on two opposite sides of the rod member 411, and an end of each of the two side plates 412 protrudes beyond the rod member 411 and has a rolling member 413 disposed thereon. Said rolling members 413 facilitate the movement of the board 2 and can prevent the board 2 from deformation due to unexpected collisions. As viewed in a radial direction of the at least one blade 22 (as shown in FIG. 6), each said second edge portion 223 protrudes beyond one of the two side plates 412 so as to trim the edge of the edge band 2a. Preferably, an extending direction of each of the two side plates 412 is vertical to an extending direction of each said abutting surface 711 so that one said abutting surface 711 and one of the two side plates 412 are abutted against two sides of the board 2 at the same time for good positioning effect and stability. The two side plates 412 are detachably assembled to the rod member 411 for easy maintenance and replacement, and the two side plates 412 can be replaced with different thicknesses so as to adjust the position of the board 2 relative to the at least one blade 22 during cutting.

The cutting device of the edge banding machine 1 further includes a third moving mechanism 50 disposed between the base 10 and the cutting assembly 20, and a height of the cutting assembly 20 relative to the conveying mechanism 3 is adjustable in a height direction by the third moving mechanism 50 according to a thickness of the board 2. The cutting device of the edge banding machine 1 further includes a fourth moving mechanism 60, the base 10 is disposed on the fourth moving mechanism 60, and the fourth moving mechanism 60 drives the base 10 to move in a direction parallel to the first direction D1 to meet different arrangement requirements.

In this embodiment, the cutting assembly 20 includes two said blades 22, and two said abutting assemblies 70 are spacedly arranged in the first direction D1. The two said blades 22 are arranged between the two said abutting assemblies 70 and spaced apart from each other in the first direction D1, and the push rod 41 is located between the two said abutting assemblies 70. The board 2 is moved in the first direction D1 to cut and trim the front end and a rear end of the edge band 2a. The two said blades 22 are spaced apart from each other and non-rotatably disposed on the transmission shaft 24 so as to simplify configurations of motor structure and circuit.

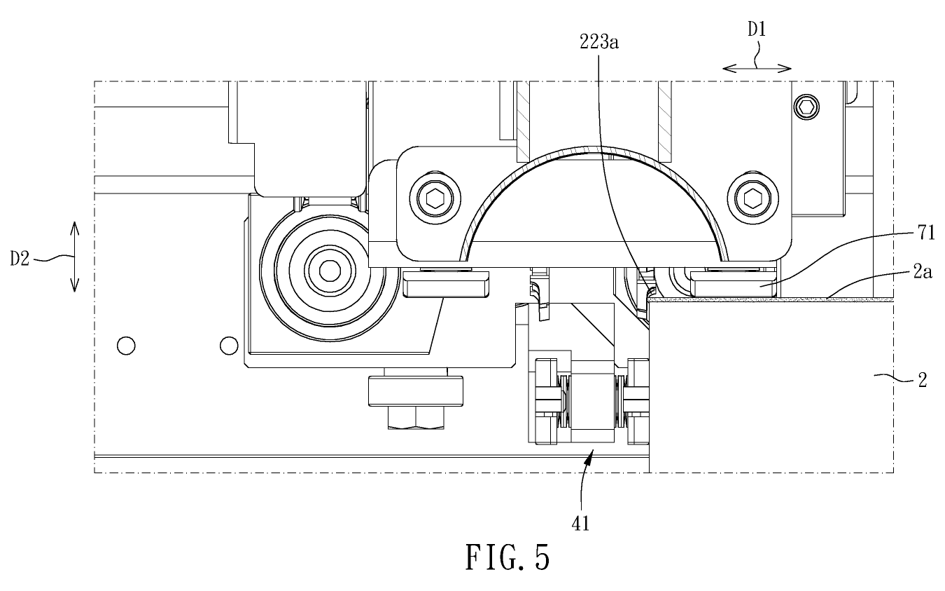

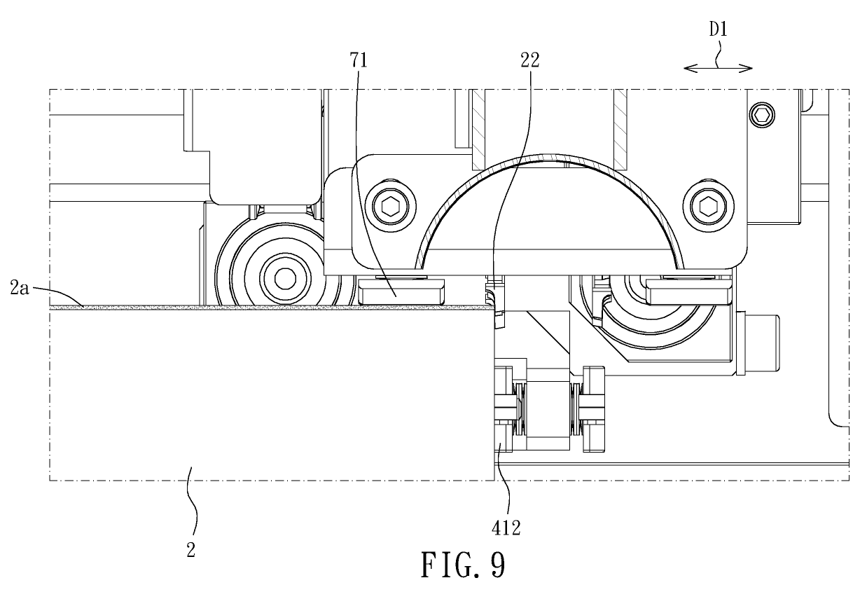

In processing, the two said blades 22 are in the original position, the push rod 41 is moved to the first position, and the conveying mechanism 3 convey the board 2 with the edge band 2a in the first direction D1 to be abutted against one of the two side plates 412. Next, the first moving mechanism 30 moves the two said blades 22 to the first cutting position, the driving motor 23 drives the two said blades 22 to rotate, and the said first edge portions 222 of one of the two said blades 22 cut off the front end of the edge band 2a, as shown in FIG. 4. Then, the first moving mechanism 30 moves the two said blades 22 to the second cutting position, one said supporting plate 71 is abutted against a side of the board 2 with the edge band 2a, and the driving motor 23 drives the two said blades 22 to rotate and the said second edge portions 223 of one of the two said blades 22 trim the edge of the cut surface of the edge band 2a, as shown in FIGS. 5 and 6. Therefore, the cutting and trimming of the front end of the edge band 2a is finished. The first moving mechanism 30 moves the two said blades 22 to the original position, the push rod 41 is moved to the second position, and the conveying mechanism 3 continues to convey the board 2 in the first direction D1, as shown in FIGS. 7 and 8. Similarly, when the board 2 is moved to a position where the rear end of the board 2 is abutted against the other of the two side plates 412, the rear end of the edge band 2a is cut and trimmed as described above, as shown in FIG. 9, which is easy to process, precise and efficient.

Although particular embodiments of the invention have been described in detail for purposes of illustration, various modifications and enhancements may be made without departing from the spirit and scope of the invention. Accordingly, the invention is not to be limited except as by the appended claims.

WHAT IS CLAIMED IS:

1. A cutting device of an edge banding machine, the edge banding machine including a conveying mechanism configured to convey a board along a first direction, the cutting device of the edge banding machine including:
a base, configured to be disposed on a side of the conveying mechanism;
a cutting assembly, including a seat, at least one blade and a driving motor, the at least one blade disposed on the seat and including a plurality of cutting teeth, each of the plurality of cutting teeth including a first edge portion and a second edge portion, each said second edge portion disposed on a side of one said first edge portion in the first direction and having an arcuate surface, the at least one blade being drivable to rotate about a rotation axis parallel to the first direction by the driving motor;
at least one abutting assembly, disposed on a side of the seat facing toward the conveying mechanism; and
a first moving mechanism, disposed between the base and the cutting assembly, the at least one blade being drivable to move back and forth in a second direction lateral to the first direction by the first moving mechanism;
wherein each of the at least one abutting assembly includes an abutting surface configured to be abutted against the board, the at least one blade partially protrudes beyond the abutting surface, and a position of the abutting surface relative to the seat is adjustable in the second direction.

2. The cutting device of the edge banding machine of claim 1, wherein each of the at least one abutting assembly includes a supporting plate and at least one adjustment member connected between the supporting plate and the seat, the supporting plate has one said abutting surface disposed thereon, and the at least one adjustment member is rotatable to drive the said abutting surface to move in the second direction.

3. The cutting device of the edge banding machine of claim 2, wherein each of the at least one abutting assembly further includes at least one elastic member disposed between one said supporting plate and the seat, and the at least one elastic member is elastically urged the said supporting plate to move in a direction remote from the seat.

4. The cutting device of the edge banding machine of claim 1, wherein each of the at least one blade is a circular saw blade, and each said second edge portion is located radially inward of the circular saw blade relative to each said first edge portion.

5. The cutting device of the edge banding machine of claim 1, wherein the at least one blade is drivable to move in the second direction between an original position, a first cutting position and a second cutting position by the first moving mechanism; when the at least one blade is in the original position, the at least one blade is free of interference with the board; when the at least one blade is in the first cutting position, at least one of said first edge portions is configured to be interfered with an edge band of the board; and when the at least one blade is in the second cutting position, at least one of said second edge portions is configured to be interfered with the edge band.

6. The cutting device of the edge banding machine of claim 1, wherein the seat includes a mounting surface and an opening disposed through the mounting surface, the at least one abutting assembly is disposed on the mounting surface, and the at least one blade protrudes beyond the mounting surface from the opening.

7. The cutting device of the edge banding machine of claim 1, further including a pushing assembly disposed on the base, wherein the pushing assembly includes a push rod and a second moving mechanism, the push rod is configured to be arranged between the at least one blade and the conveying mechanism and abuttable against the board in the first direction, and the push rod is drivable to move in a third direction vertical to the first direction between a first position and a second position by the second moving mechanism.

8. The cutting device of the edge banding machine of claim 7, wherein the push rod includes a rod member and two side plates disposed on two opposite sides of the rod member, and an end of each of the two side plates protrudes beyond the rod member and has a rolling member disposed thereon.

9. The cutting device of the edge banding machine of claim 1, wherein the cutting assembly includes two said blades, two said abutting assemblies are spacedly arranged in the first direction, and the two said blades are arranged between the two said abutting assemblies and spaced apart from each other in the first direction.

10. The cutting device of the edge banding machine of claim 8, wherein each of the at least one abutting assembly includes a supporting plate and at least one adjustment member connected between the supporting plate and the seat, the supporting plate has one said abutting surface disposed thereon, and the at least one adjustment member is rotatable to drive the said abutting surface to move in the second direction; each said supporting plate further has two inclined surfaces connected with two opposite sides of one said abutting surface, each said abutting surface extends in a direction parallel to the first direction; each said supporting plate is made of a metallic material; each of the at least one abutting assembly further includes at least one elastic member disposed between one said supporting plate and the seat, and the at least one elastic member is elastically urged the said supporting plate to move in a direction remote from the seat; each of the at least one abutting assembly includes two said adjustment members spacedly disposed through one said supporting plate and spaced apart from each other and a plurality of said elastic members, each of the two said adjustment members is a screwing member screwed to the seat, and each of the plurality of said elastic members is a spring washer sleeved to one of the two said adjustment members; each of the at least one blade is a circular saw blade, and each said second edge portion is located radially inward of the circular saw blade relative to each said first edge portion; as viewed in a radial direction of the at least one blade, each said second edge portion protrudes beyond one of the two side plates; the seat includes a mounting surface and an opening disposed through the mounting surface, the at least one abutting assembly is disposed on the mounting surface, and the at least one blade protrudes beyond the mounting surface from the opening; the cutting device of the edge banding machine further includes a third moving mechanism disposed between the base and the cutting assembly, and a height of the cutting assembly relative to the conveying mechanism is adjustable in a height direction by the third moving mechanism; the two side plates are detachably disposed on the rod member, an extending direction of each of the two side plates is vertical to an extending direction of each said abutting surface; the cutting assembly includes two said blades, two said abutting assemblies are spacedly arranged in the first direction, and the two said blades are arranged between the two said abutting assemblies and spaced apart from each other in the first direction; the cutting assembly further includes a transmission shaft disposed on the seat, the driving motor drives the transmission shaft to rotate, the two said blades are spaced apart from each other and non-rotatably disposed on the transmission shaft; the push rod is located between the two said abutting assemblies; and the cutting device of the edge banding machine further includes a fourth moving mechanism, the base is disposed on the fourth moving mechanism, the fourth moving mechanism drives the base to move in a direction parallel to the first direction.
